(19) United States
(12) Patent Application Publication
(10) Pub. No.: US 2008/0276200 A1
(43) Pub. Date: Nov. 6, 2008

(54) METHOD FOR DISPOSING A MENU LAYOUT AND RELATED DEVICE

(76) Inventors: Drew Bamford, Taoyuan County (TW); Foo Hoang, Tao-Yuan City (TW); Mario Garcia, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 12/111,979

(22) Filed: Apr. 30, 2008

Related U.S. Application Data
(60) Provisional application No. 60/915,438, filed on May 2, 2007.

(51) Int. Cl. G06F 3/048

(52) U.S. Cl. 715/841

(57) ABSTRACT

The present invention provides a method for disposing a menu layout and related device. The method includes: displaying a menu on a display screen to divide the display screen to at least a first area and a second area; receiving an input signal for indicating a control item of the menu; and displaying at least a sub-item corresponding to the control item.

This application claims the benefit of U.S. Provisional Application No. 60/915,438, filed on May 2, 2007 and included herein by reference.

### BACKGROUND OF THE INVENTION

1. Field of the Invention

The present invention relates to a method for disposing a menu layout and related device, and more particularly, to a method for disposing a menu layout and related device that can let a display screen display a frame disposition which is easy to distinguish.

2. Description of the Prior Art

Please refer to FIG. 1. FIG. 1 shows a conventional method for disposing the menu layout applied to a display screen 10 of a PC (not shown). As shown in FIG. 1, the conventional method for disposing the menu layout displays a menu 20 on top of the display screen 10, and defines the area below the menu 20 as a frame area 11 in the display screen 10. The menu 20 comprises a file item 21, an edit item 22, a view item 23, an insert item 24, a format item 25, and a tool item 26. Next, when the PC receives a first input signal for indicating the file item 21 of the display screen 20, a sub-menu 31 corresponding to the file item 21 will be displayed in a part of the frame area 11 in the meantime, wherein the sub-menu 31 comprises a group of sub-items (not shown). However, disposing the menu layout like this has a problem of being hard to distinguish between the group of sub-items and the other objects in the frame area 11.

### SUMMARY OF THE INVENTION

It is therefore one of the objectives of the present invention to provide a method for disposing a menu layout and related device that can let a display screen display a frame disposition which is easy to switch items, so as to solve the above problem.

In accordance with an embodiment of the present invention, a method for disposing a menu layout is disclosed. The method includes: displaying a menu on a display screen to divide the display screen to at least a first area and a second area; receiving an input signal for indicating a control item of the menu; and displaying at least a sub-item corresponding to the control item.

In accordance with an embodiment of the present invention, a display device is further disclosed. The display device includes: a display screen; and a control module, for displaying a menu on the display screen to divide the display screen to at least a first area and a second area, and receiving an input signal for indicating a control item of the menu, and displaying at least a sub-item corresponding to the control item.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a conventional method for disposing the menu layout applied to a display screen of a PC.

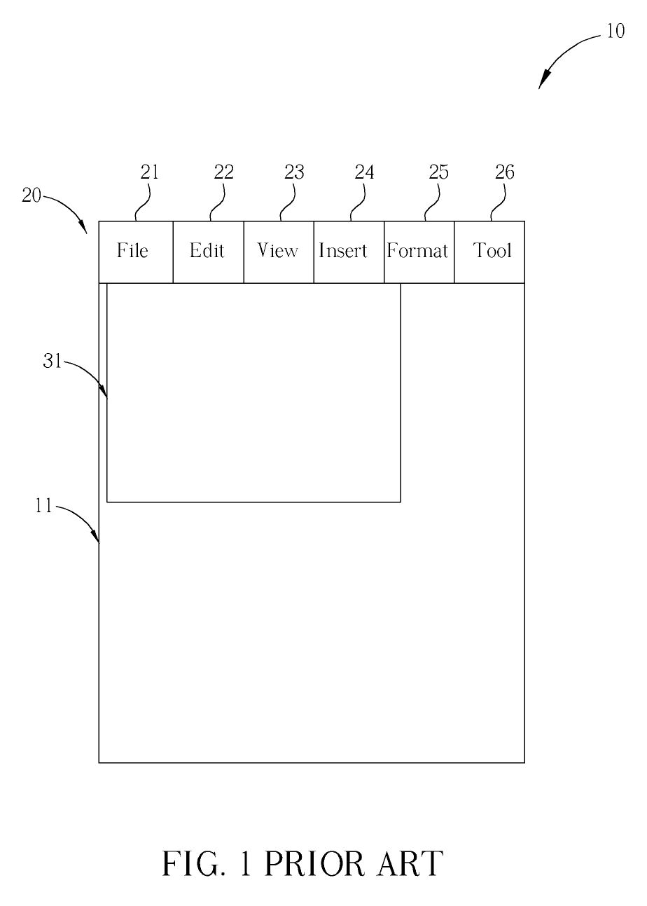

FIG. 2 shows a simplified diagram of a first frame of a display screen of the smart cellphone in accordance with a first embodiment of the present invention.

FIG. 3 shows a simplified diagram of a second frame of the display screen of the smart cellphone in accordance with the first embodiment of the present invention.

FIG. 4 shows a simplified diagram of a third frame of the display screen of the smart cellphone in accordance with the first embodiment of the present invention.

FIG. 5 shows a simplified diagram of a fourth frame of the display screen of the smart cellphone in accordance with the first embodiment of the present invention.

FIG. 6 shows a simplified diagram of a fifth frame of the display screen of the smart cellphone in accordance with the first embodiment of the present invention.

FIG. 7 shows a simplified diagram of a first frame of the display screen of the smart cellphone in accordance with a second embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”.

The present invention relates to a method for disposing a menu layout that is capable of letting a display screen of an electronic device display a frame disposition that is easy to distinguish. This document will illustrate several exemplary embodiments that apply the method for disposing the menu layout in the present invention. However, a person of average skill in the pertinent art should be able to understand that the present invention can be applied for various similar types of electronic devices and is not limited to the particular embodiments described in the following paragraphs or to the particular manner in which any features of such embodiments are implemented.

In general, the method for disposing the menu layout can be applied to the display screens of all kinds of electronic devices. By way of example but not limitation, the method for disposing the menu layout applied to the display screen of a smart cellphone is disclosed in accordance with the present invention. In addition, under a condition of not affecting the technical disclosure of the present invention, the smart cellphone will be used as an example to illustrate the method for disposing the menu layout in the present invention.

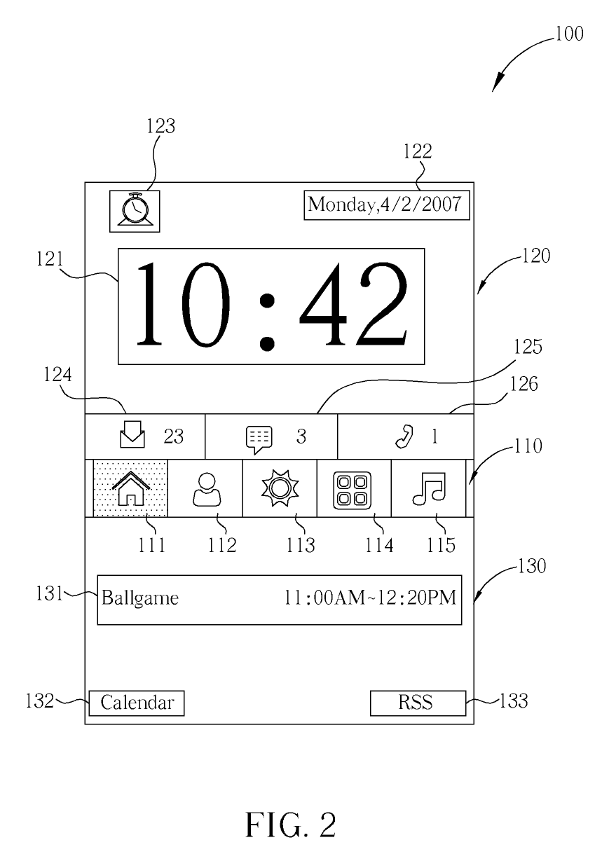

Please refer to FIG. 2. FIG. 2 shows a simplified diagram of a first frame of a display screen 100 of the smart cellphone (not shown) in accordance with a first embodiment of the present invention. The smart cellphone includes a display device (not shown), and the display device includes a display screen 100 and a control module (not shown). The control module is indicated as a processor. As shown in FIG. 2, the method for disposing the menu layout disclosed by the present invention displays a menu 110 on the display screen 100 to divide the display screen 100 to a first area 120 and a second area 130, wherein the menu 110 comprises a home item 111, a favorite people item 112, a weather item 113, a launcher item 114, and a music item 115. Next, when the smart cellphone receives a first input signal for indicating the home item 111 of the display screen 110, a group of sub-items corresponding to the home item 111 will be displayed in the first area 120 in the meantime. The group of sub-items comprises a time item 121, a date item 122, an alarm clock item 123, an unread mail item 124, an unread message item 125, and a miss call item 126. In addition, the frame displayed in the second area 130 is corresponding to at least an object in a database. For example, the database can comprise a memorandum 131, a calendar 132, and an RSS 133. Furthermore, it is very obvious that area sizes of the first area 120 and the second area 130 are both larger than area size of the menu 110 as shown in FIG. 2. In another embodiment the first area 120 can have a pair of side edges that are not adjacent to the boundary of the display screen 100. In other words, the top and bottom side edges of the first area 120 can be not adjacent to the boundary of the display screen 100. Please note that the above embodiment is only for an illustrative purpose and is not meant to be a limitation of the present invention.

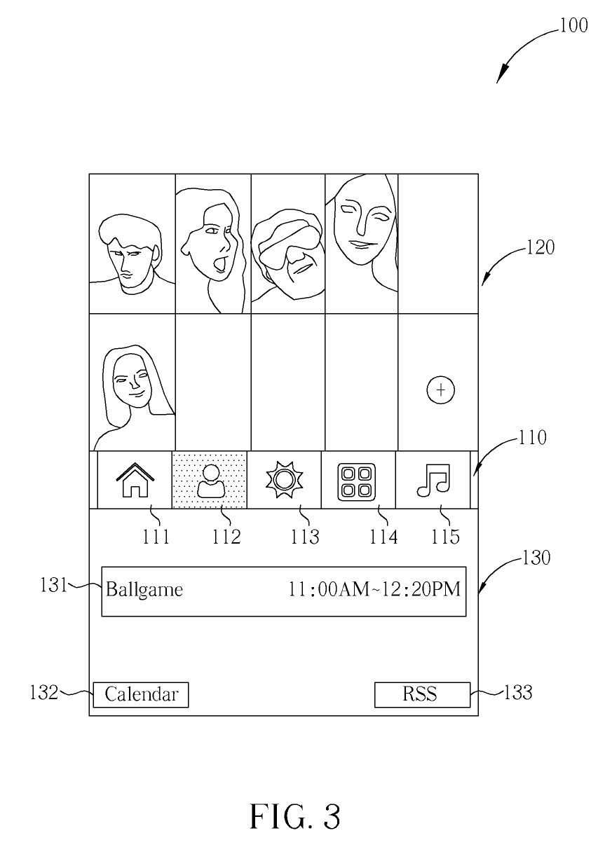

Please refer to FIG. 3. FIG. 3 shows a simplified diagram of a second frame of the display screen 100 of the smart cellphone in accordance with the first embodiment of the present invention. As shown in FIG. 3, when the smart cellphone receives a second input signal for indicating the favorite people item 112 of the display screen 110, a group of sub-items corresponding to the favorite people item 112 will be displayed in the first area 120 in the meantime. The group of sub-items comprises a plurality of name items. In addition, same as the first frame shown in FIG. 2, the frame displayed in the second area 130 is still corresponding to at least an object in a database without being affected by the second input signal.

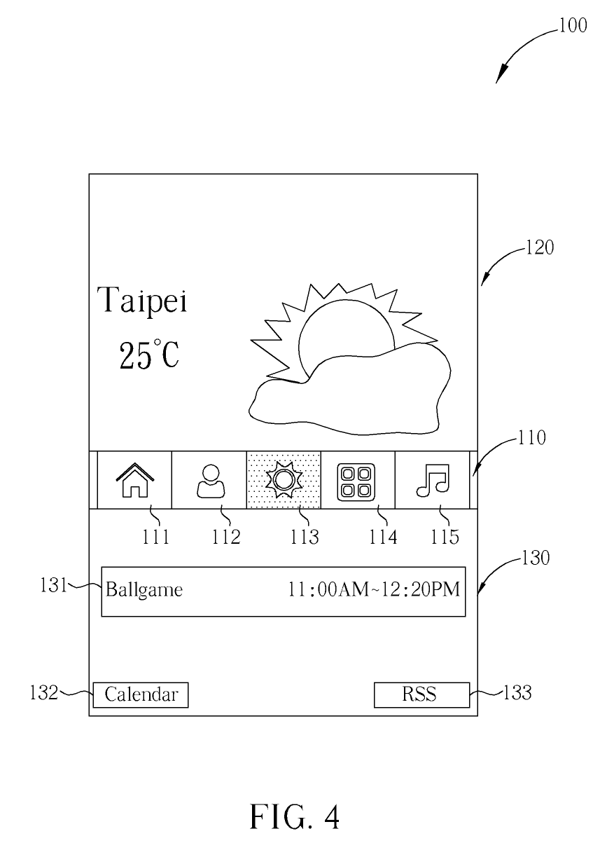

Please refer to FIG. 4. FIG. 4 shows a simplified diagram of a third frame of the display screen 100 of the smart cellphone in accordance with the first embodiment of the present invention. As shown in FIG. 4, when the smart cellphone receives a third input signal for indicating the weather item 113 of the display screen 110, a group of sub-items corresponding to the weather item 113 will be displayed in the first area 120 in the meantime. The group of sub-items comprises a plurality of weather forecast items. In addition, same as the first frame shown in FIG. 2, the frame displayed in the second area 130 is still corresponding to at least an object in a database without being affected by the third input signal.

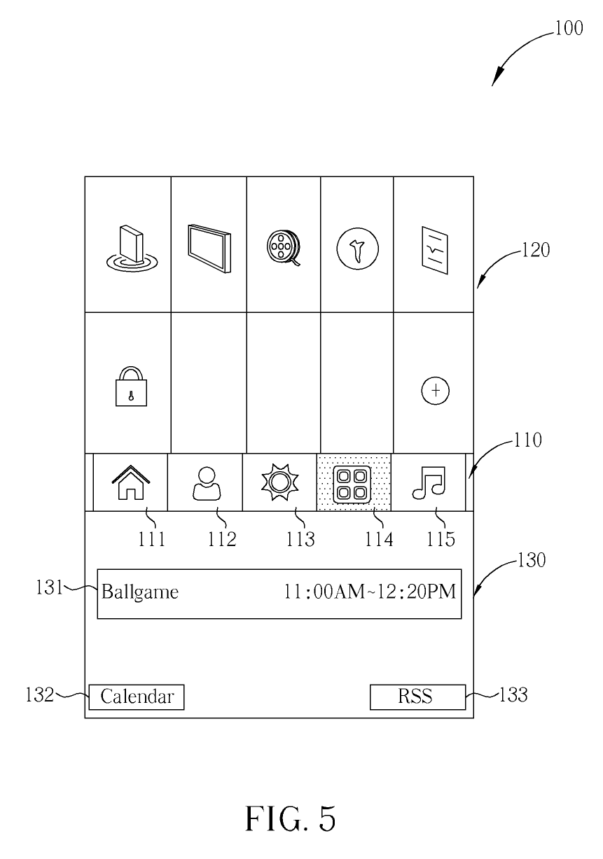

Please refer to FIG. 5. FIG. 5 shows a simplified diagram of a fourth frame of the display screen 100 of the smart cellphone in accordance with the first embodiment of the present invention. As shown in FIG. 5, when the smart cellphone receives a fourth input signal for indicating the launcher item 114 of the display screen 110, a group of sub-items corresponding to the launcher item 114 will be displayed in the first area 120 in the meantime. The group of sub-items comprises a plurality of application program items. In addition, same as the first frame shown in FIG. 2, the frame displayed in the second area 130 is still corresponding to at least an object in a database without being affected by the fourth input signal.

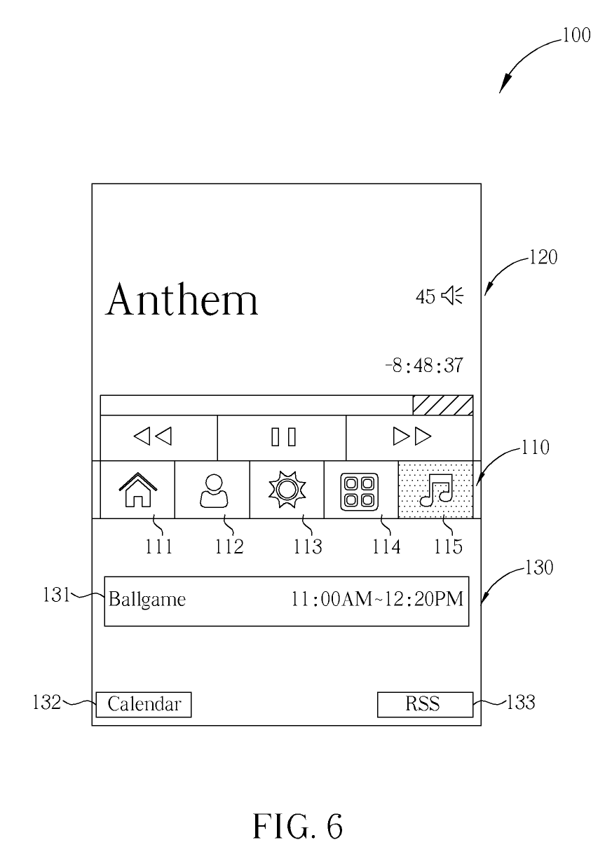

Please refer to FIG. 6. FIG. 6 shows a simplified diagram of a fifth frame of the display screen 100 of the smart cellphone in accordance with the first embodiment of the present invention. As shown in FIG. 6, when the smart cellphone receives a fifth input signal for indicating the music item 115 of the display screen 110, a group of sub-items corresponding to the music item 115 will be displayed in the first area 120 in the meantime. The group of sub-items comprises a music player item and a plurality of music playing control items. In addition, same as the first frame shown in FIG. 2, the frame displayed in the second area 130 is still corresponding to at least an object in a database without being affected by the fifth input signal.

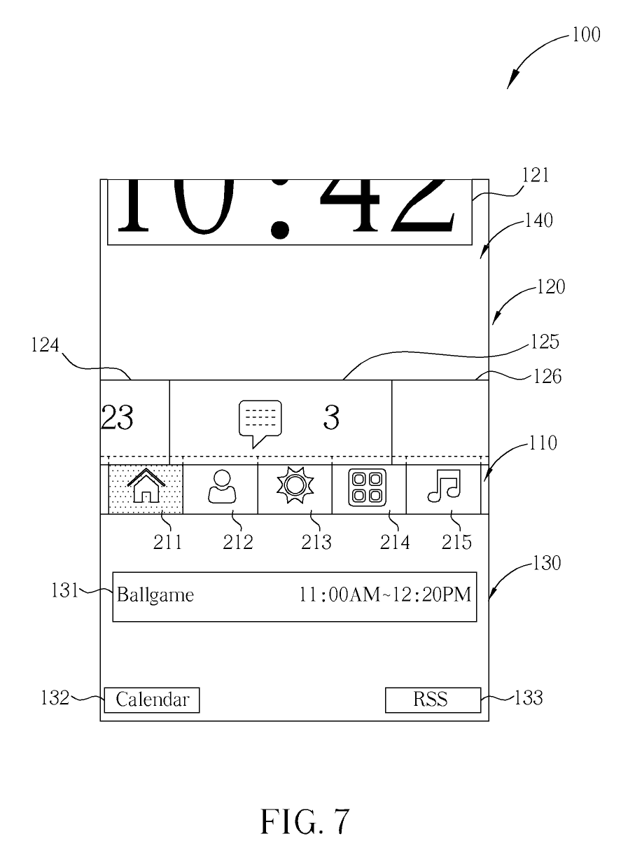

Please refer to FIG. 7. FIG. 7 shows a simplified diagram of a first frame of a display screen 100 of the smart cellphone in accordance with a second embodiment of the present invention. As shown in FIG. 7, the method for disposing the menu layout disclosed by the present invention displays a menu 110 on the display screen 100 to divide the display screen 100 to a first area 120 and a second area 130, wherein the menu 110 comprises a home item 211, a favorite people item 212, a weather item 213, a launcher item 214, and a music item 215. Next, when the smart cellphone receives a first input signal for indicating the home item 211 of the display screen 110, a group of sub-items corresponding to the home item 211 will be displayed in a sub-menu 140 in the meantime. A part of the sub-menu 140 can cover over the first area 120. In other words, area size of the sub-menu 140 can be larger than that of the first area 120. As shown in FIG. 7, although the group of sub-items comprises a time item 121, a date item 122, an alarm clock item 123, an unread mail item 124, an unread message item 125, and a miss call item 126, however, since the area size of the sub-menu 140 is larger than that of the first area 120, only the unread mail item 124, a part of the time item 121, a part of the unread message item 125, and a part of the miss call item 126 can be seen in the first frame shown in FIG. 7.

In addition, the frame displayed in the second area 130 is corresponding to at least an object in a database. For example, the database can comprise a memorandum 131, a calendar 132, and an RSS 133. Furthermore, it is very obvious that area sizes of the first area 120 and the second area 130 are both larger than area size of the menu 110 as shown in FIG. 7. In another embodiment the first area 120 can have a pair of side edges that are not adjacent to the boundary of the display screen 100. In other words, the top and bottom side edges of the first area 120 can be not adjacent to the boundary of the display screen 100. Please note that the above embodiment is only for an illustrative purpose and is not meant to be a limitation of the present invention.

Briefly summarized, the method for disposing the menu layout and related display device and portable device disclosed by the present invention can display a menu on a display screen to divide the display screen to at least a first area and a second area, so as to let a user be able to clearly see the sub-menu shown in the first area easily when the user switches the items in the menu. The frame displayed in the second area 130 will not affected by the operation of switching the items, and thus there is no conventional problem of simultaneously displaying the sub-menu and other unrelated objects in the same area. In other words, the method for disposing a menu layout and related device disclosed by the present invention can let the display screen display a frame disposition which is easy to distinguish and easy to switch the items.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for disposing a menu layout, comprising:
displaying a menu on a display screen to divide the display screen to at least a first area and a second area;
receiving an input signal for indicating a control item of the menu; and
displaying at least a sub-item corresponding to the control item.

2. The method of claim 1, wherein area size of the second area is not smaller than that of the menu.

3. The method of claim 1, wherein the first area has a pair of side edges that are not adjacent to a boundary of the display screen.

4. The method of claim 1, wherein the step of displaying at least a sub-item corresponding to the control item comprises:
displaying the sub-item corresponding to the control item in the first area.

5. The method of claim 1, wherein the step of displaying at least a sub-item corresponding to the control item comprises:
displaying the sub-item corresponding to the control item in a sub-menu.

6. The method of claim 5, wherein a part of the sub-menu covers over the first area.

7. The method of claim 5, wherein the sub-menu covers over a part of the first area.

8. The method of claim 1, wherein a frame displayed in the second area is corresponding to at least an object in a database.

9. The method of claim 8, wherein the database comprises a memorandum, a calendar, and an RSS.

10. The method of claim 1, wherein the menu comprises a home item, a favorite people item, a weather item, a launcher item, and a music item.

11. The method of claim 10, wherein a group of sub-items corresponding to the home item comprises a time item, a date item, an alarm clock item, an unread mail item, an unread message item, and a miss call item.

12. The method of claim 10, wherein a group of sub-items corresponding to the favorite people item comprises at least a name item.

13. The method of claim 10, wherein a group of sub-items corresponding to the weather item comprises at least a weather forecast item.

14. The method of claim 10, wherein a group of sub-items corresponding to the launcher item comprises at least an application program item.

15. The method of claim 10, wherein a group of sub-items corresponding to the music item comprises a music player item and a plurality of music playing control items.

16. A display device, comprising:
a display screen; and
a control module, for displaying a menu on the display screen to divide the display screen to at least a first area and a second area, and receiving an input signal for indicating a control item of the menu, and displaying at least a sub-item corresponding to the control item.

17. The display device of claim 16, wherein area size of the second area is not smaller than that of the menu.

18. The display device of claim 16, wherein the first area has a pair of side edges that are not adjacent to a boundary of the display screen.

19. The display device of claim 16, wherein a frame displayed in the second area is corresponding to at least an object in a database.

20. The display device of claim 19, wherein the database comprises a memorandum, a calendar, and an RSS.
